(19) United States
(12) Patent Application Publication
(10) Pub. No.: US 2023/0290030 A1
(43) Pub. Date: Sep. 14, 2023

(54) VIRTUAL SIZING & FIT TOOL

(71) Applicant: Phoenix Apparel LLC, Portland, OR (US)

(72) Inventor: Stephanie Muhlenfeld, Portland, OR (US)

(21) Appl. No.: 18/181,417

(22) Filed: Mar. 9, 2023

Related U.S. Application Data
(60) Provisional application No. 63/269,092, filed on Mar. 9, 2022.

(51) Int. Cl. G06T 13/40; G06T 19/20

(52) U.S. Cl. CPC G06T 13/40; G06T 19/20; G06T 2200/08

(57) ABSTRACT

The disclosed systems and method disclose sizing and fit tools for apparel, headwear, and footwear that rely on virtual models. The virtual models are created from body scans of multiple human models. One or more of the body scans can be spliced at a splicing location. The systems and methods determine a body measurement for the body scan(s) at the splicing location. The spliced body scan(s) are compiled to create a virtual model. The virtual model can additionally be based on body shape of the body scans or the spliced body scans. Some example systems and methods also generate fit data based on the virtual model and optionally a garment size.

### CROSS REFERENCE TO RELATED APPLICATIONS

This application claims the benefit of and priority to co-pending U.S. Provisional Pat. Application Serial No. 63/269,092, filed Mar. 9, 2022, entitled VIRTUAL APPAREL SIZING EXPERIENCE, which is incorporated herein by reference in its entirety for all purposes.

### BACKGROUND

Each human being is shaped and sized differently, which results in challenges for people to find well-fitting apparel, footwear, and headwear that are typically offered in retail markets in standardized sizing. Standardized sizing groups or ranges are created by companies for their core customer and span a range of measurement associated with each size category. Sizing charts are created from various methods, some brands root sizing charts in data, others will create sizing charts up and down the size scale from their base size model, and most will copy competing brand’s sizing. Sizing charts of the body are different from sizing charts of the garment and are often further separated by sizing charts displayed to the consumer. Overtime, these body charts become further disjointed from the product creating further complications in navigating size and fit for both manufacturers and consumers. Sizing charts also do not typically account for body shape or size differences between various body parts. People often spend substantial time trying to find a good fit for the garment they want to purchase, which can require them to physically travel to one or more stores or order garments for delivery and try on several garments to find a good fit. Even then, sometimes the fit is still not quite right in one or more areas of their body, but many people often settle for the “best” fit that is available to them. The time and cost to find garments with good fit is substantial and frustrating to most consumers. Alternative custom fitted garments are prohibitively expensive to most people.

Sizing tools have become popular to help people find properly fitted apparel, footwear, and headwear. Many of these tools use personal data, such as physical body measurements or photographs or other images of the consumer. Storing such personal data raises data privacy concerns that are difficult to manage. Data privacy laws differ between countries and even differ within various states or regions within a country. In a global economy, and specifically in the retail industry, consumers purchase apparel, footwear, and headwear from a source that may be in a different country, state, or region that applies different data privacy laws. This lack of consistency on data privacy laws makes it difficult for apparel, footwear, and headwear manufacturers retailers to navigate the many different sets of data privacy laws to be able to provide consumer specific sizing tools.

Therefore, the art would benefit from a convenient, efficient virtual sizing and fit tool that allows consumers to find well-fitting apparel, footwear, and headwear without the burden of traveling to multiple stores or ordering from multiple sources while maintaining data privacy of individual consumers.

### BRIEF DESCRIPTION OF THE DRAWINGS

Non-limiting and non-exhaustive embodiments of the invention are described with reference to the following drawings. In the drawings, like reference numerals refer to like parts throughout the various figures, unless otherwise specified, wherein:

FIG. 1 is a system block diagram showing an example virtual sizing and fit tool.

FIG. 2 shows an example image of a human model with a corresponding virtual body scan of that human model.

FIG. 3 shows another example virtual body scan of a human model.

FIG. 4 shows example splices of virtual body scans of human models.

### DETAILED DESCRIPTION

The disclosed virtual sizing and fit tool includes systems and methods that create custom virtual models — often called “avatars” — that are created from body measurement data from multiple human models. Humans are discussed as the example animal throughout this disclosure, but one of skill in the art will recognize that the same techniques can be applied to any animal. The custom avatars are uniquely able to provide consumers a best match to help them find well-fitting apparel, headwear, and footwear and also to help manufacturers of such apparel, headwear, and footwear to develop sizing and fit data for their products. For sake of ease, all apparel, headwear, and footwear are included in the disclosed systems and methods; however, apparel or garments will be used as the examples in this description without limiting the scope of this disclosure.

The disclosed virtual sizing and fit tools give consumers control when shopping for their garments in both size and fit, which improves the retail shopping experience, increases efficiency of the sales process for both consumers and manufacturers, and reduces waste and frustration with purchases of ill-fitting garments. This control over their shopping experience gives consumers the ability to select a virtual model that has similar body measurements and optionally a similar body shape to the consumer. The consumer-selected virtual model is used to size garments in a virtual environment and/or on an e-commerce platform. The consumer selects the virtual model by first providing certain body measurements that are typically used to size on traditional retail websites. In an example embodiment, a female consumer provides their bra size (torso band measurement and cup size) and their pant size. The disclosed systems and methods match the consumer with one or more available virtual models that have similar measurements. If the disclosed systems and methods provide multiple virtual models for the consumer to consider, the consumer is prompted to select the virtual model with whom the consumer most identifies. Additional information for each virtual model can be included, such as fit experience information, body shape, typical issues with fit associated with their body size and/or shape, additional body measurements, and the like. The consumer controls the selection of the virtual model, which helps them identify with the virtual model as garments are fitted to the model and fit information is provided to inform the consumer’s purchasing decisions.

In contrast, conventional systems and methods leave a consumer without control over the sizing and fit information for a garment. Most consumers are left to guess their size and navigate words and size charts that are brand-specific to each garment. Those size charts vary substantially in fit and size range between brands, which makes the guess work difficult for consumers and ultimately results in wasted time when they incorrectly guess their size for a particular garment of interest because it can lead exchanges or returns of garments or to the consumer settling for an ill-fitting garment or a garment that fits in a less an ideal manner. With the uncertainty that this consumer guessing process produces, many consumers grow wary of and frustrated with the retail process to find well-fitting garments and manufacturers face increased expenses to process returned or exchanged products and to retain customers. In addition to consumer frustration and the inefficiency and increased cost to consumers and manufacturers alike, substantial amounts of inventory are wasted with many garments damaged upon return, unavailable for recycling, or recycled to secondhand discounters.

Further, many brands use models that do not represent their typical customers. Most models tend to be taller and more evenly proportioned than an average consumer. Even brands that use a virtual model (typically a virtual model representing a single human model body scan), tend to base their size and shape from their fit model’s measurements, not an average consumer’s measurements. This leads to many situations in which the size and fit of the garment presented to the consumer looks and feels differently when the consumer wears it as compared to the depiction of the same garment on the fit model.

The disclosed virtual sizing and fit tools also provide benefits to in-store shopping to make the experience more engaging and efficient. Consumers traveling to brick-and-mortar stores to purchase garments also face challenges finding well-fitting garments. Many stores do not have garments in the full range of available sizes, do not have personal service experiences for consumers, and provide little to no sizing and fit information to consumers. This leads to consumers facing in-store shopping experiences that feel transactional, do not produce results of the purchase they traveled to the store to make, and generally lack a feeling of brand loyalty or shopping experience satisfaction.

The disclosed sizing and fit tools produce a new technique for envisioning garment sizing and fit on a virtual model that removes the uncertainty of the conventional methods that require consumers to guess size and fit based on non-standardized brand data. The disclosed sizing and fit tools also help brands create size charts based on real, human or “fit” models representing a range of fit models that are based on a range of body size and shape. The virtual model data can be analyzed with anthropometry data, such as data that is specific to a demographic or geographic region, to produce the virtual models reflective of the size and shape of consumers.

In some embodiments, the disclosed sizing and fit tools consider gravity influenced sizing and fit on the virtual models in addition to the body measurements and body shape. The influence of gravity affects how garments fit in various body areas, such as the breasts for example. Gravity also affects garment fit for fit and less fit consumers that wear the same size or consumers of different ages that may wear the same size. A person with a toned body often has a different body measurements and body shape than someone who does not have a toned body because of their muscle density and the way gravity has less of a downward pull or impact on such dense tissue compared to gravity’s effects on less dense tissue. The same force of gravity pulling on dense tissue has less of an impact than on less dense tissue. Likewise, as the human body ages, portions of the body tend to become less structured or robust and may need support in areas that did not previously need support, even for the same user in the same size garment. For the aging body like the body with less dense tissue, gravity again places the same force on less dense tissue, which leads to greater downward force on the less dense tissue than the denser tissue.

The sizing and fit data generated by the virtual models and using the new techniques described herein help garment designers and manufacturers create their sizing and fit charts. The compiled data about the virtual models is more aligned with the consumers purchasing the garments instead of the fit models that tend to be different sizes and/or shapes than the usual consumers purchasing the garments. Often, that mismatch between the fit model and the exemplary consumer often leads to size and fit charts based on data for a slim portion of the population and one that is not likely similar to the consumer that is actually purchasing the garment(s).

The disclosed systems and method create virtual models from multiple body scans of human models. The body scans are compiled, sized for body measurements at one or multiple locations, and optionally analyzed for body shape. The body scans are spliced at certain splicing locations, which can include but are not limited to the bust, waist, low hip, high hip, thigh, bicep, across the shoulders, height, arm length, torso length, circumference of any limb at various location along its length, and the like. These measurements can be taken from any one or more different views on the body scan, such as the front, back, side, and perspective views. Many and up to thousands of body scans can be compiled together and organized via various statistical methods and means by body size and optionally body shape to create a single virtual model.

Further, different ratios can be measured on one or multiple body scans that are then used to create the virtual models. For example, female bodies tend to have a naturally smaller waist than their hips and bust than males, which results in a greater waist-hip and waist-bust ratio than for males. Human body shapes for any gender also can differ in the percentage of difference between these body measurements, such as the waist to bust ratio, the waist to hips ratio, or the bust to hips ratio. The body scans can be grouped or compiled by similar body proportions based on these ratios or simply based on the body measurements, as discussed above.

In an example, body scans are analyzed for breast size and shape in all four quadrants of the breast. Breast measurements are taken in each of the four quadrants to determine breast size data. A breast shape is assigned to each breast based on the analyzed body scan data. The breast shape data can be generated based on contour information, ratios determined between the measurements in different quadrants or within the same quadrants, the location of various measurements taken in each quadrant with respect to other body measurements such as chest wall, band size, waist and hip measurements, and the like.

Further, the breast shape to torso measurement ratio is also determined as that gives an assessment of how a garment would fit the virtual model — and ultimately the consumer shopping with the virtual model — throughout the consumer’s torso. The virtual models can be used to help brands create their sizing and fit charts for their garments, such as a bra or fitted shirt size and fit chart in this example in which breast size and shape is analyzed. The sizing and fit charts created are used internally to engineer the garments and create the grading direction or range between each size. This range is used to create the grade or the sizing of the garments up and down the offered size range. Grading for each product can also be different based on the product’s purpose. By utilizing compiled sizing data to inform sizing and grade ranges for each size range and type of product, it allows the brand to be more accurate with the fit and sizing to the actual consumer.

The disclosed systems and methods can include artificial intelligence (AI) and machine learning (ML) techniques that help improve the quality of results in various modules or stages of the systems and methods. For example, an AI or ML model can be used to help translate the ingested 3D body scans of the human models into the 3D virtual scans by continuously discerning between smaller details between images that differ in size, shape, contour, depth, etc. The trained AI or ML models doing this 3D scan translation can base their analysis on the previously ingested body measurements and/or body shapes along with any feedback provided by any source, such as the consumer, a manufacturer, a data scientist, manually measured data, .csv or the like.

Further, the AI and ML techniques can be applied to help extract body measurements from multiple 3D body scans and compile them through multiple statistical formulas to extract the translated 3D virtual body scan. Such AI and ML models can be built based on historical sizing threshold data identified in existing 3D body scan and/or 3D translated, virtual body scans. The AI and ML models can also help to create sizing thresholds between sizes or to identify fit experience data within a size, for example. In these embodiments, the AI and ML models would provide a body measurement and/or body shape threshold that defines a particular size or size range and can generate fit experience data based on body size and/or body shape data.

The AI and ML models can also be trained to recognize patterns in the body measurement and/or body shape data that further refines the sizing match or helps to generate fit experience data for a virtual model in some examples. The patterns can be used to generate fit experience data that can be used by consumers to better understand the fit they will experience with the selected garments on their correlating virtual model or can be used to improve sizing information for manufacturers of garments. For example, the AI or ML model could recognize that a virtual model with a certain body shape and body measurements on the material used in the garment (e.g., an hourglass or pear body shape needs a smaller size when the fabric used to make the garment exceeds a certain elasticity value) to need different sizes in tops and bottoms and different sizes when they consider garments designed for different purposes (e.g., fitness v. formal wear). These patterns that the AI or ML model detects can be mapped to the creation of a virtual model that would wear different sizes based on the type of garment, the material or fabric in the garment, the closure or fit style of the garment, and the like to improve the overall sizing, fit, and experience data for the consumer.

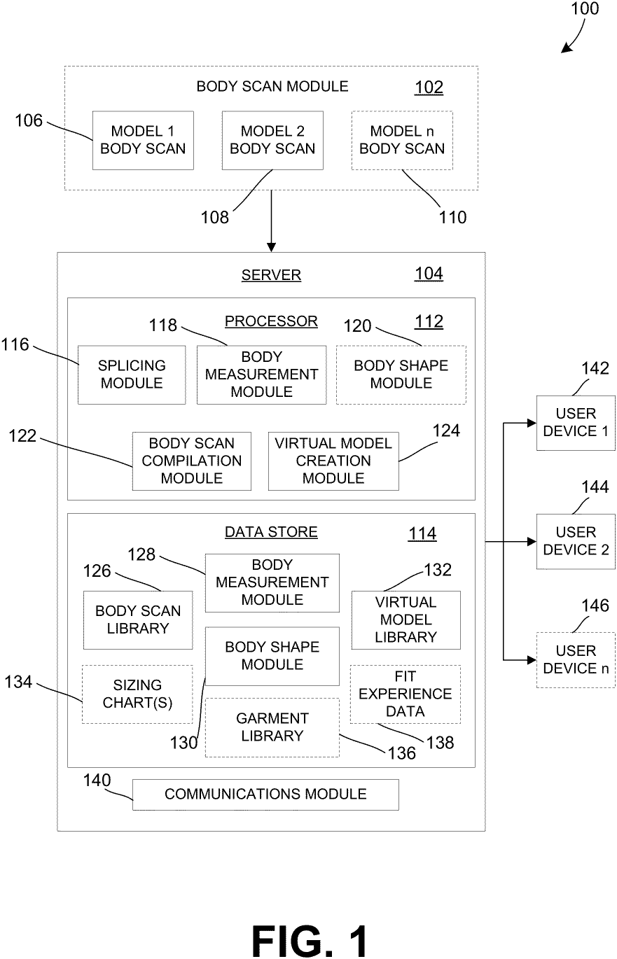

Turning now to FIG. 1, an example system 100 block diagram showing a virtual sizing and fit tool has a body scan module 102 and a server 104. The body scan module 102 can be any suitable module, component, user device, optical imaging element, or the like that takes and/or receives body scans of a human model. As discussed above, body scan module 102 receives the body scans for human models that are various sizes and body shapes. Specifically, the body scan module 102 receives scans from a first model 106, a second model 108, and any multiple number of models 110. The body scan module 102 can be remote from, yet electronically coupled to, the server 104 although in some alternative examples they are integrated into a single computing unit.

The server 104 includes a processor 112 and a data store 114. The processor 112 includes a splicing module 116, a body measurement module 118, a body shape module 120, a body scan compilation module 122, and a virtual model creation module 124. The processor 112 receives the body scans 106, 108, 110 from the body scan module 102. The splicing module 116 splices one or more of the received body scans 106, 108, 110. The splicing module 116 “splices” or takes a planar, cross-sectional slice of the body scan of interest (any one or more of the multiple received body scans) at a splicing location. The planar, cross-sectional slice of the body scan of interest is a 2-dimensional (2D) or 3-dimensional (3D) slice that provides detailed contour, perimeter, circumference, length, depth, or the like of an image. The splicing module 116 can also optionally provide tissue information, such as tissue density and shape, such as tissue data about a breast that impacts sizing and fit of bras, shirts, and other garments.

The splicing module 116 can take splices of any one or more of the body scans, which include image(s) of a fit model. In one embodiment, the splicing module 116 takes a splice of all of the received body scans at the same splicing location. A splice analyzes the image of the body scan for a measurement at a particular “splicing location” or specific location on the model’s virtual body scan presented in the image. The splice is a planar representation of the body scan at the splicing location of the virtual body scan and can provide body measurement data and body shape data. The splicing module 116 can take body measurements across or around one or more areas of the splice. The splicing module 116 can also determine body shape for one or more areas of the splice by evaluating the bounds of the shape or form of the area of interest from a characteristics of the splice, such as a changing depth, slope, grade, angle, or shape, and/or from one or more body measurements about the splice or elsewhere on the body scan. The splicing module 116 can translate images of the body scan into 2D or 3D representations of the fit model by evaluating the image for depth, contour, and other image characteristics that translate a 2D image to a 3D rendition of the image of the fit model’s body scan. The 2D splices with the depth, shape, contour, etc. data are used to create the correlating 3D splices. In another embodiment, the splicing module 116 takes a splice of the received body scan(s) at multiple splicing locations. In yet another example, the splicing module 116 takes splices of all received body scans and splices them at the same multiple splicing locations.

The splicing location(s) can be grouped for a particular garment or could be a whole body analysis. The whole body analysis can include a set of measurements that should be able to depict sizing and fit information for any garment that a consumer wishes to select. The whole body analysis takes measurements, contours, shape, density, tissue data, or other important sizing and fit information for a set of the same locations and measurements on the bodies of each model providing a body scan. In the whole body example, the entire body can be transformed into a 3D virtual body scan.

The body measurement module 118 ingests the body measurement and body shape data used to translate the 2D image of the body scan into a 3D model and also uses the 3D model to take its own body measurements for various body parts. The body shape module 120 also ingests the body measurement and body shape data from the splicing module 116 to use the 3D model to determine body shape from the spliced body scans and from the body measurements. The body shape module 120 takes measurements data from the body measurement module or directly from the splicing module 116 to create shape information that includes data such as contour, depth, ratios between certain body measurement (e.g., hips to waist), and any other data that helps determine a body shape of a virtual body scan from the 3D body scan.

The body scan compilation module 122 compiles the body scans, which means it overlays the 3D virtual body scans from different human models onto each other to group body scans of the same or a similar size, fit, shape, etc. together. The compilation of the body scans can be focused or fit to each other at the splicing location(s) to normalize each body scan relative to the others. If a body scan is overlaid on another body scan, and its size of a body measurement or body shape at a splicing location is within a range of value difference from the second body scan, it can be considered the same or a similar size or fit. If, however, the body scan is overlaid on another body scan, and its size of the body measurement or body shape at the splicing location is outside of or exceeds a range of value difference from the second body scan, then it can be considered a different size or fit from the first body scan.

The virtual model creation module 124 create a virtual model from the body scan compilation. It can create multiple virtual models, each one having a compilation of body scans from multiple ingested body scans from different fit models. The virtual model creation module 124 can compile virtual models from a different number of virtual body scans for each virtual model, in some examples. Each virtual model has at least two and oftentimes several body scans compiled into a single virtual model. While this example discussed the compilation of 3D virtual body scans, the same compilation can occur with the 2D scans if the translation technique of determining the 3D virtual body scan from the 2D virtual body scan is unavailable for any reason. In this alternative embodiment, the virtual body scan would be a 2D compilation of virtual body scans from multiple human models.

The data store 114 of the server 104 includes a body scan library 126, a body measurement module 128, a body shape module 130, and a virtual model library 132. Each of these modules in the data store 114 store the produced data from the body scan module 102 or the processor 104 from their correlating processor modules 118, 120, 124. The body scan library 126 stores the body scans ingested from the body scan module 102, including the 2D images of the fit models and the 3D image processed translations of the fit model images. The body measurement module 128 stores the body measurement data determined by the body module 118. The body shape module stores the body shape data determined by the body shape module 120. The virtual model library 132 stores the virtual models created by the virtual model creation module 124.

The data store 114 on the sever 104 also optionally includes sizing chart(s) 134, a garment library 136, and fit experience data 138. As discussed above, garment manufacturers create size chart(s) from fit data. In this case, the size charts stored in the sizing chart(s) module of the data store 114 are based on the virtual models created by the processor 112 of the disclosed system 100. The garment library 136 stores data about each garment that could be presented to the customers using this tool 100. The garment library 136 stores sizing and fit data related to each garment present to consumers using the tool 100. The fit experience data 138 includes fit data relating to each virtual model created by the virtual model creation module 124 of the processor 112. The fit experience data 138 includes data relating to the way garments tend to fit the virtual model based on fit experience data that trends among the body scans and human model data ingested to create that corresponding virtual model. The trends can include specific information about the manner in which a particular garment tends to fit a person with the body measurements and shape similar to that of the selected virtual model.

The server 104 includes a communications module 140 that communicates with both the body scan module 102 and any external user devices 142, 144, 146 that are electronically coupled to the server 104. The user device 142, 144, 146 each can connect individually to the server 104 or can coordinate with each other. When individually connected, the consumer could be using the user device 142 to peruse garments from the garment library 136 on an electronic commerce or “e-commerce” website using a virtual model. In another example, multiple consumers each use their respective devices 142, 144, 146 to join a virtual pixel streaming environment to shop for garments in a virtual shopping experience.

Any one or more of the modules for disclosed system 100 shown in FIG. 1 can rely on an AI or ML model to analyze images or produce useful sizing and fit data. As discussed above, as the AI or ML model is trained over time, the sizing and fit data results are continuously improved. Because AI and ML models tend to be particularly good at improving image data analysis over time, the quality of the translation of the 3D images of human models to the 3D images of virtual body scans likewise improves over time. The 3D models will evolve to be more accurate versions of their 3D image counterpart, which will, in turn, improve the sizing and fit results that are based on the 3D models.

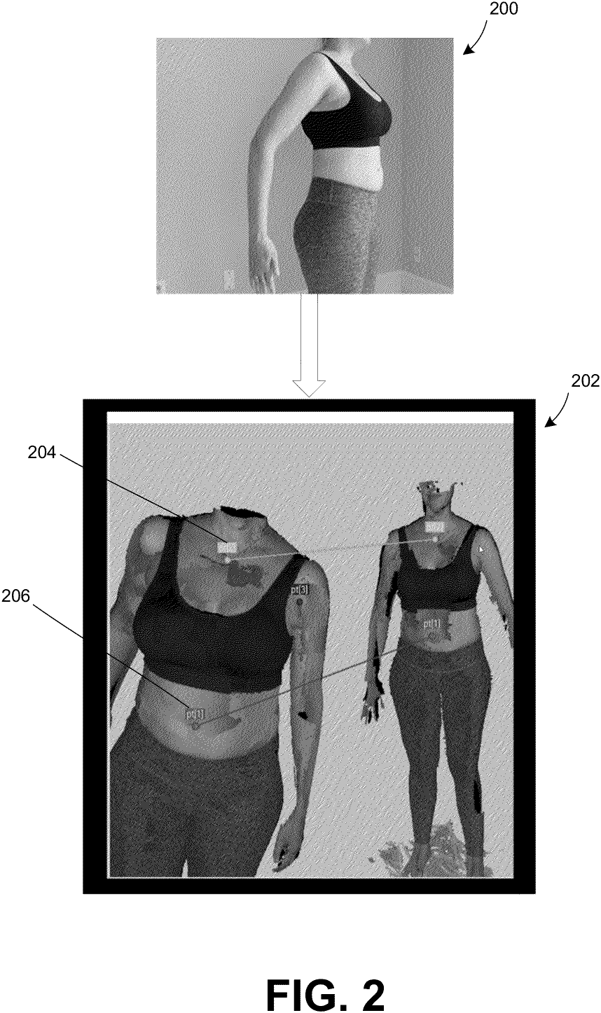

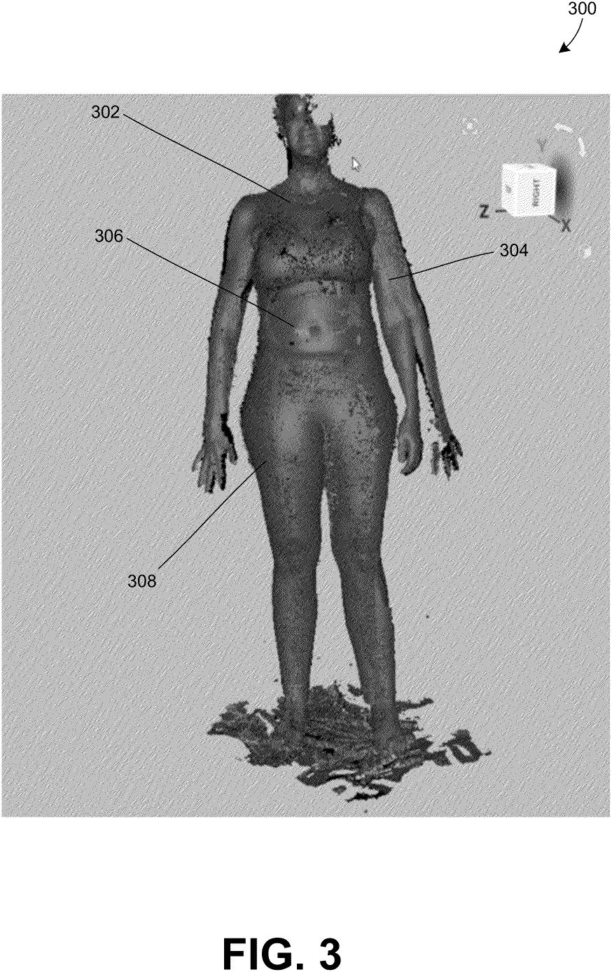

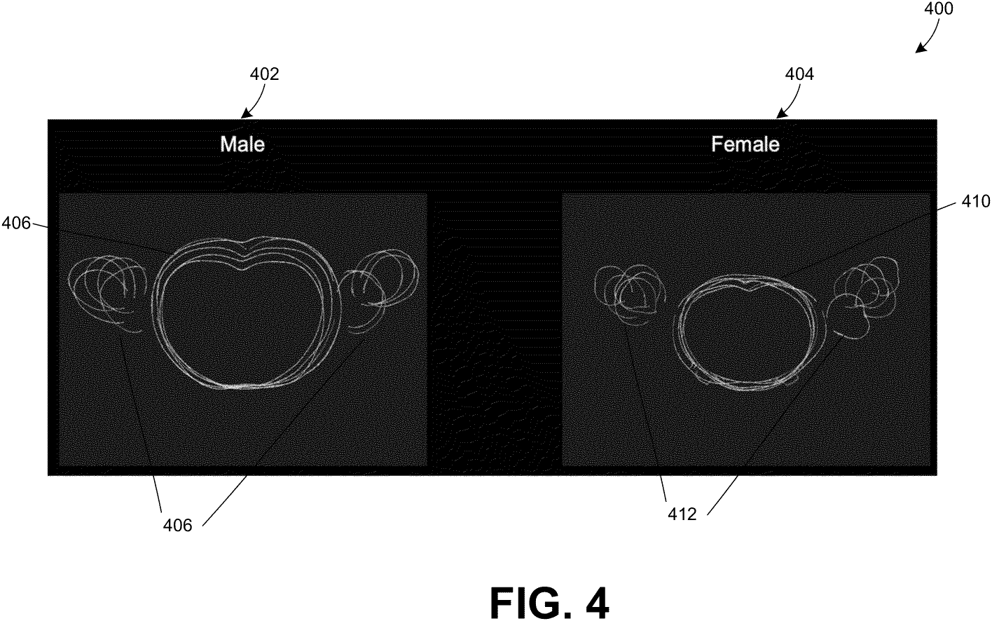

FIG. 2 shows a body scan image of a fit model 200 that is in 3D that is translated to a 3D virtual body scan 202 of the same body scan. There are two locations 204, 206 at which respective body measurements are taken to create the 3D virtual body scan 202. FIG. 3 shows a whole-body 3D virtual body scan 300. The disclosed systems and methods take body measurements of the 3D virtual body scan 300 at many locations throughout the corresponding 3D image. In particular, body measurements are taken throughout the human model’s chest 302, arm 304, torso 306, and legs 308 in the example shown in FIG. 3, which is represented by the shaded areas in each respective body part or region. FIG. 4 shows an example of overlaid splices 400 taken at a splicing location for male 402 and female 404 (or those that identify with one or both genders) virtual scans. This example set of overlaid splices 400 are taken at the same location on the male torso 406 and arms 408 and the female torso 410 and arms 412. They illustrate the differences between similarly sized and shaped splices at the same splicing location.

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. The systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

What is claimed is:

1. A method of creating a virtual model, comprising:
receiving multiple body scans, each body scan correlating to a respective animal model;
splicing a first body scan of the multiple body scans at a splicing location, the first body scan corresponding to a first animal model;
determining a body measurement from the spliced first body scan;
determining the body measurement at the splicing location for a second body scan, the second body scan corresponding to a second animal model;
compiling the spliced first body scan and the second body scan; and
creating a virtual model based on the compiled spliced first body scan and the second body scan.

2. The method of claim 1, wherein each of the respective animal models is within a defined size range.

3. The method of claim 2, wherein the defined size range includes sizes that correlate to multiple garments.

4. The method of claim 3, wherein the multiple garments are manufactured by different brands.

5. The method of claim 1, further comprising correlating the multiple respective animal models to a defined size range based on a non-liner statistical model.

6. The method of claim 1, wherein the splicing location is within a torso region of the first animal model in the first body scan.

7. The method of claim 1, further comprising:
splicing the second body scan at the splicing location;
determining the body measurement at the splicing location for the second body scan based on the spliced second body scan; and
compiling the spliced first body scan and the spliced second body scan; and
creating the virtual model based on the compiled spliced first body scan and the spliced second body scan.

8. The method of claim 1, further comprising:
splicing each of the multiple body scans at the splicing location;
determining the body measurement for each of the multiple body scans from the respective spliced body scans;
compiling the multiple spliced body scans; and
creating a virtual model based on the compiled multiple spliced body scans.

9. The method of claim 1, wherein the splicing location is a first splicing location and the body measurement is a first body measurement, and further comprising:
splicing the first body scan at a second splicing location;
determining a second body measurement for the second splicing location of the spliced first body scan;
determining the second body measurement at the splicing location for the second body scan;
compiling the spliced first body scan and the second body scan; and
creating a virtual model based on the compiled spliced first body scan and the second body scan at the first splicing location and the second splicing location, respectively.

10. The method of claim 1, further comprising:
determining a body shape for each of the multiple body scans; and
creating the virtual model based on the body shape for each of the respective multiple body scans and the compiled spliced first body scan and the second body scan.

11. The method of claim 1, further comprising:
splicing each of the multiple body scans at respective multiple splicing locations;
determining the body measurement for each of the multiple body scans at each of the respective splicing locations;
compiling respective spliced body scans based on the determined body measurements for each of the multiple body scans at each of the respective multiple splicing locations;
creating the virtual model based on the compiled spliced multiple body scans.

12. The method of claim 11, wherein the respective multiple splicing locations includes one or more locations on animal arms, legs, torso, shoulders, breasts, hips, and legs.

13. The method of claim 11, further comprising:
determining a body shape for each body part or portion of a body part correlating to each body measurement determined at each respective multiple splicing location; and
creating the virtual model based on the compiled spliced multiple body scans and the body shape for each body part or portion of the body part for all respective multiple splicing locations.

14. The method of claim 1, further comprising coupling the virtual model with a garment size.

15. The method of claim 14, wherein the garment size is associated with a specific garment that includes pants, shirt, bra, jacket, intimate wear, swimwear, athletic wear, footwear, safety garments, wearable safety equipment, headwear, or formal wear.

16. The method of claim 14, further comprising outputting the virtual model and the garment size.

17. The method of claim 14, further comprising generating garment fit data based on the virtual model and the garment size.

18. The method of claim 17, further comprising outputting the garment fit data.

19. A virtual model creation system, comprising:
a processor configured to:
receive multiple body scans, each body scan correlating to a respective animal model;
splice each of the multiple body scans at a splicing location;
determine a body measurement and a body shape at the splicing location for each of the multiple spliced body scans;
compile the multiple spliced body scans based on the determined body measurement and the body shape for each of the multiple spliced body scans; and
create a virtual model based on the compiled multiple spliced body scans; and an output configured to transmit the virtual model.

20. The system of claim 19, wherein the processor is further configured to generate garment fit data based on the virtual model and a garment size.
